(19) United States
(12) Patent Application Publication
(10) Pub. No.: US 2016/0371789 A1
(43) Pub. Date: Dec. 22, 2016

(54) Insurance System And Method For Allocation of Risk in Damage Replacement of Electrical Storage Devices

(71) Applicants: Dan C. Kelley, Austin, TX (US); Colin Balfour Williams, Austin, TX (US)

(72) Inventors: Dan C. Kelley, Austin, TX (US); Colin Balfour Williams, Austin, TX (US)

(21) Appl. No.: 15/188,628

(22) Filed: Jun. 21, 2016

Related U.S. Application Data
(60) Provisional application No. 62/182,740, filed on Jun. 22, 2015.

(51) Int. Cl. G06Q 40/08; G06Q 20/10

(52) U.S. Cl. CPC G06Q 40/08; G06Q 20/102

(57) ABSTRACT

A method, and a system for allocating risk of loss for a replacement cost of an on-board electric energy storage device damaged as a result of a collision involving a battery-powered or hybrid vehicle in which the battery is damaged, transferring ownership of the damaged energy storage device to a Payor of a policy. The value of battery is determined, and an amendment or revision to an insurance policy is made. Payment to the original owner of the battery is then calculated, depending on the existing insurance policy, based on one or more of the actual cash value of the damaged battery and the replacement cost of the battery.

### CROSS-REFERENCE TO RELATED APPLICATION

This application claims benefit under 35 U.S.C. 119(e) of U.S. Provisional Patent Application No. 62/182,740, filed Jun. 22, 2015, the entire contents of which are incorporated herein by reference.

### BACKGROUND OF THE INVENTION

1. Field of the Invention

The present invention is directed to systems and methods for allocation of risk of loss for damaged electrical storage devices, such as batteries.

2. Discussion of Related Art

Current Standard or Non-Standard Automobile Insurance policies, Service Plans, Extended Service Plans, Warranty Programs, Battery Replacement Programs (if any) or other means of risk allocation covering damage to on-board electric energy storage devices do not provide risk allocation whereby the damaged on-board electric energy storage device is replaced at no additional cost to the consumer. If any risk allocation is provided for damage to on-board electric energy storage devices, it is only for the payment of “actual cash value” or “depreciated value” of the device in the event of a collision.

For example, when a typical automobile collision policy compensates for damage to the battery, the policy will only pay the actual cash value (depreciated value) of the battery. This leaves the consumer, who needs to replace the damaged battery, to pay the difference between the actual cash value and the replacement value. The situation is even worse for consumers who have no collision coverage at all. In that case, the vehicle insurance pays nothing towards replacement of the damaged battery.

Many consumers suffer a financial burden as a result of this rarely known fact in terms of what is actually paid if their on-board electric energy storage device (battery) is damaged in a collision involving their battery-powered or hybrid vehicle, whether the accident is their fault or not. Furthermore, most consumers are not equipped to dispose of the damaged on-board electric energy storage device, much less assess its salvage value.

Thus, there exists a need for a system and method of risk allocation that solves the above-mentioned problems.

### SUMMARY OF THE INVENTION

An object of the present invention is to provide a method, and a system for carrying out the method, for allocating risk of loss for a replacement cost of an on-board electric energy storage device damaged as a result of a collision involving a battery-powered or hybrid vehicle in which the battery is damaged.

According to an aspect of the invention, the method includes transferring ownership of the damaged energy storage device to a Payor of a policy. The value of battery is determined, the determination being based on provisions of an existing insurance policy such as a Standard or Non-Standard Automobile Insurance Policy, an endorsement to an insurance policy such as a Standard or Non-Standard Automobile Insurance Policy; an amendment or revision of a Standard or Non-Standard Automobile Insurance Policy; a Service Plan; an Extended Service Plan; a Warranty; a Battery Replacement Program or any other manner of risk allocation for the replacement cost of the on-board electric energy storage device. Payment to the original owner of the battery is then calculated, depending on the existing insurance policy, based on one or more of the actual cash value of the damaged battery and the replacement cost of the battery.

The present invention is also directed to a system and method for allocating risk of loss for a replacement cost of other electric energy storage devices, such as a battery or “solar battery” or “geothermal battery” or “hydroelectric battery” or “wind battery” that has been accidentally damaged.

According to this aspect of the invention, ownership of the damaged energy storage device is transferred to the Payor of the policy. The value of the battery is determined, the determination being based on provisions of an existing insurance policy such as a Standard or Non-Standard Property Insurance Policy, or a Standard or Non-Standard Business Owners' Policy, or other Insurance Services Office policy, an endorsement to an insurance policy such as a Standard or Non-Standard Property Insurance Policy or a Standard or Non-Standard Business Owner's Policy or other Insurance Services Office policy; an amendment or revision of a Standard or Non-Standard Property Insurance Policy or other Insurance Services Office policy; an amendment or revision of a Standard or Non-Standard Business Owners' Policy or other Insurance Services Office policy; a Service Plan; an Extended Service Plan; a Warranty; a Battery Replacement Program or any other means of risk allocation for the replacement cost of the electric energy storage device used in storing electricity converted from sun rays (e.g. solar energy), changes in temperature (e.g. geothermal energy,) moving water (e.g. hydroelectricity) or wind. Payment to the original owner of the battery is then calculated, depending on the existing insurance policy, based on one or more of the actual cash value of the damaged battery and the replacement cost of the battery.

In another embodiment, the invention also provides a system and method for allocating risk of loss for the replacement cost of an on-board electric energy storage device damaged as a result of a collision. This embodiment includes transfer of ownership to the Payor of the damaged on-board electric energy storage device.

In accordance with one aspect of the invention, if the vehicle and the device have coverage for collision, then a first gap coverage product, which will be referred to as “Product A” of risk allocation is offered and/or obtained by the consumer, prior to an accident, to provide gap coverage to make the consumer whole in the event of accidental damage to the battery. As discussed above, a vehicle collision policy only pays the actual cash value (depreciated value) of the battery to the Payee (holder of the collision policy). This leaves a gap in coverage since the consumer will still be responsible to pay the difference between the depreciated value reimbursed by the insurance company providing the collision policy and the replace cost, i.e., the cost to actually purchase a new battery.

Product A of risk allocation would provide, for a consumer who has collision coverage, a gap coverage that would pay the Payee (i.e., the consumer) the difference between the appraised actual cash value of the device (e.g., battery), that is, the depreciated value (which is all that the collision coverage would pay), and the replacement cost of the device. Thus, the combined payments received by a consumer carrying both collision coverage and the coverage afforded by Product A would total up to the full replacement cost of the device.

The actual cash value of the device is based on factors such as manufacturer, age and depreciation to compute the “actual cash value”, while the replacement cost is the cost to acquire a new device, such as from an original equipment manufacturer or an after-market product meeting OEM specifications. The replacement cost is generally greater than the actual cash value of the device, and “Product A” would pay the difference in these values to the Payee.

If the vehicle with the on-board electric energy device does not have coverage for damage to the device as a result of a collision, then the consumer is in the unfortunate position of receiving no payment at all for the damaged battery. However, if the consumer obtains a second gap coverage product, which will be referred to as “Product B,” as a method of risk allocation, this product would provide for payment of the entire replacement cost, which is the cost to acquire a new device, again, such as from an original equipment manufacturer or an after-market product meeting OEM specifications.

As will be understood, with both “Product A” and “Product B” of risk allocation, the Payor under each of these products assesses the salvage value and ownership of the damaged on-board electric energy storage device transfers to the Payor.

In yet another embodiment, the invention also provides a system and method for allocating risk of loss for the replacement cost of an electric energy storage device (e.g. “solar storage battery”, “geothermal battery”, “hydroelectric battery”, “wind turbine storage battery”) accidentally damaged. This embodiment includes transfer of ownership to the Payor of the damaged electric energy storage device. If the device is covered for accidental damage under either a Standard or Non-Standard Property Insurance Policy or a Standard or Non-Standard Business Owner's Policy or other Insurance Services Office policy, then “Product A” of risk allocation would provide for payment of the difference between the appraised actual cash value of the device, i.e., what the accidental damage policy would typically pay, and the replacement cost.

Again, in this situation, Product A covers the gap between what the accidental damage policy would pay and the replacement cost. Actual cash value of the device is based on factors such as manufacturer, age and depreciation to compute the “actual cash value”, while replacement cost is the cost to acquire a new device to replace the damaged device. The replacement cost is generally greater than the actual cash value of the device, and “Product A” would pay the difference in these values to the Payee.

If the electric energy device does not have coverage for damage to the device as a result of accidental damage, then normally the consumer, i.e., the owner of the battery, would not be reimbursed at all. However, if “Product B” has been purchased, Product B's risk allocation would provide for payment of the full replacement cost, which is the cost to acquire a new device to replace the damaged device.

With both “Product A” and “Product B” of risk allocation, the Payor assesses the salvage value and ownership of the damaged electric energy storage device transfers to the Payor.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a flow chart illustrating an exemplary method of risk allocation in accordance with an embodiment of the present invention; and

FIG. 2 is a schematic diagram of a typical environment in which the method of the present invention is carried out.

### DETAILED DESCRIPTION OF THE PRESENTLY PREFERRED EMBODIMENTS

A system and method are disclosed for allocating risk of loss for the replacement cost of an on-board electric energy storage device (e.g. a rechargeable battery, etc.) damaged as a result of collision involving the vehicle containing the on-board storage device. The system and method provide for a transfer of ownership of the damaged on-board electric energy storage device to the Payor and assessment of a salvage value. The system and method provide for an allocation of risk of loss to account for: (a) a replacement cost of an original equipment installed on-board electric energy storage device such as a battery damaged as a result of a collision; and (b) a non-original installed on-board electric energy storage device such as a battery damaged as a result of a collision. Thereafter, a rating calculation would be applied based on whether:

(1) there is current “collision” coverage on the vehicle and the device; or

(2) there is no current “collision” coverage on the vehicle and device.

The system and method also include determining the costs applicable in (1) and (2) based on:

(a) the model and manufacturer of the device,

(b) the model and manufacturer of the vehicle in which the device is installed,

(c) the age of the on-board electric energy storage device if not original equipment, and

(d) based on other internal and external sources of data containing acceptable profile values for characteristics of customers.

A system and method are provided for allocating risk of loss for the replacement cost of other electric energy storage devices (e.g. a battery or “solar storage battery” or “geothermal battery” or “wind turbine storage battery”) for use in storing electricity converted from sun rays (e.g. solar energy), or changes in temperature (e.g. geothermal), or from water (e.g. hydroelectricity) or from wind, when the loss of the electric energy storage device (e.g. a battery or “solar storage battery” or “geotheiinal battery” or “hydroelectric battery” or “wind turbine storage battery”) occurs from accidental damage from a covered event. The system and method provide for a transfer of ownership of the damaged electric energy storage device to the Payor and assessment of a salvage value. The system and method provide for an allocation of risk of loss to account for: (a) a replacement cost of an original equipment electric energy storage device such as a battery accidentally damaged; and (b) a non-original electric energy storage device accidentally damaged. Thereafter, a rating calculation would be applied based on whether:

(1) there is current coverage either under a Standard or Non-Standard Property Insurance Policy or Standard or Non-Standard Business Owner's Policy or other Insurance Services Office policy for the accidental damage to the electric energy storage device;

(2) there is no current coverage either under a Standard or Non-Standard Property Insurance Policy or Standard or Non-Standard Business Owner's Policy or other Insurance Services Office policy for the accidental damage to the electric energy storage device.

The system and method also include determining the costs applicable in (1) and (2) based on:

(a) the model and manufacturer of the electric energy storage device,

(b) the age of the electric energy storage device, and

(c) based on other internal and external sources of data containing acceptable profile values for characteristics of customers.

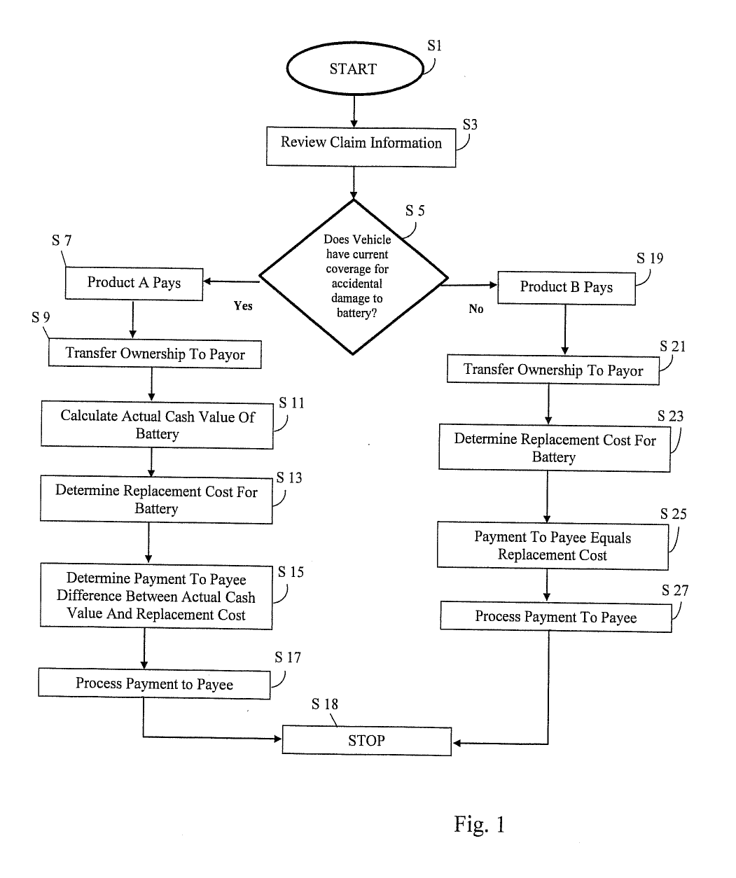

FIG. 1 is a flow chart illustrating an embodiment of a method according to the present invention for the case in which the energy storage device is for a vehicle. The flow chart covers the situation in which consumers who do have vehicle collision coverage have previously purchased Product A, and consumers who have no vehicle collision coverage have purchased Product B.

The method starts, at Step S1, and proceeds to Step S3, in which the policy provider, or a service employed by the policy provider, reviews claim information. In the exemplary embodiment, such information would typically be submitted by the owner of a vehicle in which the damaged battery is installed.

As the method is directed to processing accidental damage, in Step S3, preferably evidentiary information provided by the owner of the vehicle is reviewed. Examples of such information required to be submitted with a claim are proof, or a verified statement, such as an affidavit, to the effect that no other warranty or insurance coverage providing for the replacement cost of the on-board electric energy storage device (e.g., battery) is in place for the vehicle for which a claim is being submitted. Also, preferably proof of accidental damage would be required at this stage, for example, a copy of an accident report that has been filed, or a report provided by the police or other appropriate agency.

According to an aspect of the invention, a claim can be submitted, for example, by the owner of the vehicle visiting the policy provider's website.

At Step S5, based on information provided by the owner, or based on stored information relating to the owner and/or the vehicle, it is determined whether the vehicle has current coverage for accidental damage to the battery. In the case of an automobile, such coverage would be in the form of coverage for collision damage. In the case, for example, of a battery used in a different context, such coverage would be in the form of a policy that covers accidental damage to the battery.

If the answer is “yes” at Step S5, and if the owner of the vehicle has purchased Product A, the flow continues to Step S7, at which the processing for payment under Product A begins. In this process, at Step S9, ownership of the damaged battery is transferred to the Payor, in this case the Product A policy provider or an agent or assignee thereof. In Step S11, the actual cash value of the battery is calculated.

In determining the actual cash value of the battery, i.e., the current value of the battery, various factors are taken into account, including, but not limited to the manufacturer, age and depreciation. At Step S13, the replacement cost of the battery is determined. The replacement cost is the cost to replace the battery, i.e., to acquire a new battery, either original equipment manufactured or after-market manufactured meeting OEM specifications.

At Step 15, the payment to the Payee is calculated as the difference between the actual cash value and the replacement cost. The replacement cost is almost always higher than the actual cash value and Product A will pay the difference between these values to the Payee. In Step S17 payment to the Payee is processed. For example, a check may be mailed to the Payee, or an electronic payment or credit applied to an account of the Payee. The process ends at Step S18. As a result of the processing under Product A, the owner of the battery will be made whole for the gap between what the standard vehicle collision policy pays, namely the actual cash value (depreciated value) of the battery and the replacement cost. With these combined payments, the owner can replace the car with no, or minimal, out of pocket expense.

If the answer at Step S5 is “no”, then assuming the owner has purchased Product B, the process flow proceeds to the processing for payment under Product B at Step S19. At Step S21 ownership of the damaged battery is transferred to the Payor, in this case the policy provider or an agent or assignee thereof. At Step S23, the replacement cost of the battery is determined. The replacement cost is the cost to replace the battery, i.e., to acquire a new battery, either original equipment manufactured or after-market manufactured meeting OEM specifications.

At Step 25 the payment to the Payee is calculated. In Product B, the payment to the Payee equals the replacement cost of the battery. Since the replacement cost is more than the difference paid in Product A, Product B would typically be a more expensive product that Product A.

In Step S27 payment to the Payee is processed. For example, a check may be mailed to the Payee, or an electronic payment or credit applied to an account of the Payee. The process ends at Step S18.

It is noted that with both Product A and Product B, the Payor assesses the salvage value (this step is not shown in the flowchart for Product B) and ownership of the damaged electric energy storage device (e.g., battery) transfers to the Payor.

The exemplary method depicted in FIG. 1 illustrates the case in which the battery is used in a vehicle. The same method can be used for allocating risk in the case of a damaged battery alone. In this case, instead of determining, for example, whether a vehicle is covered by collision insurance, it is determined, at Step S5 whether or not there is current coverage either under a Standard or Non-Standard Property Insurance Policy or Standard or Non-Standard Business Owner's Policy or other Insurance Services Office policy for the accidental damage to the electric energy storage device. If there is such coverage, the flow proceeds to payment processing under Product A (assuming Product A has been purchased), at Step 7. If there is no accidental damage coverage, the flow proceeds to payment processing under Product B (assuming Product B has been purchased), at Step S19.

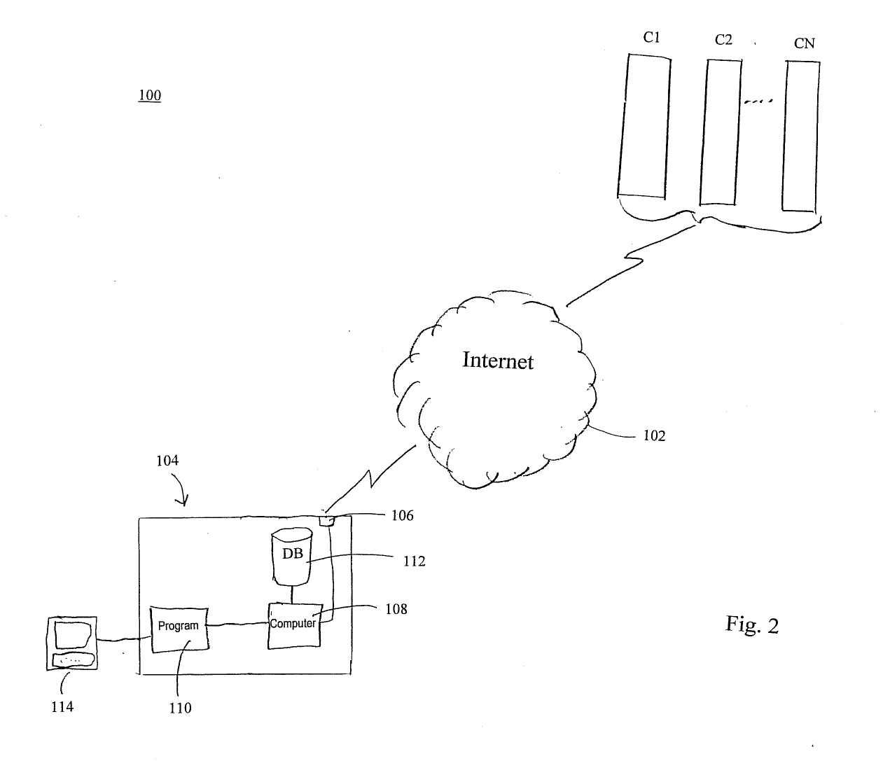

FIG. 2 is a schematic representation of an exemplary electronic environment on which the above method can be executed. System 100 includes a computer based internetwork, such as the Internet 102 or other network, clients C1 . . . CN, which would, for example, be used by customers, or potential customers, to obtain coverage, review the policy provider's website and report accidents or make other claims, check their coverage, or the like, via the Internet 102. Policy provider server 104 preferably is configured to perform, among other things, a Web server function, for example, to provide a Web based connection to current and potential customers.

The server 104 includes a Web interface 106, which, for example, supports connection to the Internet and, for example, supporting the website of the policy provider. The server 104 also includes a computer 108 configured to run software stored, for example, in a memory 110. The computer 108 also can access data, for example customer data, stored on database 112. Note that although the various components of the server 104 are shown schematically in FIG. 2 as being located together, it is understood that one or even all of the components can actually be arranged in a distributed fashion, for example making use of cloud based computing and storage or the like.

For inputting required information to the server 104, or for updating information resident on the server 104, e.g., by employees or agents of the policy provider, one or more terminals 114 may be used. Other forms of data input can be used as well, such as remotely located terminals, apps running on remote devices, wired or wirelessly connected, etc.

In executing the method of FIG. 1, a customer, using one of the clients C1 . . . CN, submits an appropriate claim for a damaged battery, for example by accessing the website of the policy provider. The website, in a preferred embodiment, would require the user to sign in with a password and user ID. For a new user, seeking to purchase a protection plan, registration would be requested.

In the case of an existing client, who has already purchased one of Product A or Product B, the server 104, under the control of the computer 108, preferably reviews customer information in the database 112 to verify the customer and seek other information regarding the customer, vehicles covered by the customer's policies, and the type of coverage, e.g., Product A or Product B, that covers the user's battery. The server also reviews information regarding the claim itself, the type of battery, any police or other reports, etc., to assist in determination of, for example, the actual cash value of the damaged battery.

The computer 108, making use of information from the database 112, and other sources of information, calculates the actual cash value of the battery, once sufficient information has been received, or retrieved, relating to the current state of the damaged battery, the manufacturer, etc., as discussed above.

For example, the computer 108, using information about the battery, can use a standard depreciation algorithm either internally stored or accessed from a website known for providing an application for determining the depreciation. Similarly, the computer 108 can use external websites, alone or in combination with stored information and algorithms, to determine the replacement cost, based on the model of battery that is input by the customer. In this way, the steps of the method illustrated in FIG. 1 can be carried out by the system 100.

In order for the customer to obtain protection under Product A or Product B, the customer would purchase Product A if the customer carries collision coverage, or other accident coverage, for the battery. On the other hand, the customer would purchase Product B if the customer is not covered by a plan that covers loss for a damaged battery. As discussed above, with Product A, the Payor pays the customer the difference between the salvage value (actual cash value) of the damaged battery and the replacement cost. On the other hand, with Product B, the Payor pays the customer the replacement cost. Since the replacement cost is usually greater than the actual cash value, Product B will be more expensive than Product A. In one variant, a deductible might be applied to any of the payments, for example, to reduce the cost of the gap protection product.

The method and system described herein provides a novel manner of allocating the risk of loss for the replacement cost of an on-board storage device, e.g., a rechargeable battery, or the like.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for a policy provider allocating risk of loss for a damaged electric energy storage device by one of a first gap coverage product of the policy provider and a second gap coverage product of the policy provider, the method comprising:
receiving, by the policy provider, claim information from a customer relating to the damaged electric energy storage device;
reviewing, by the policy provider, the received claim information to determine whether or not the electric energy storage device is covered by a vehicle collision policy that covers accidental damage to the electric energy storage deceive,
(a) if the electric energy storage device is covered by a vehicle collision policy, then applying the first gap coverage product by:
calculating the actual cash value of the damaged electric energy storage device;
determining the replacement cost for the damaged electric energy storage device; and
paying the customer the difference between the calculated actual cash value and the replacement cost; and
(b) if the electric energy storage device is not covered by a vehicle collision policy, then applying the second gap coverage product by:
determining the replacement cost for the damaged electric energy storage device; and
paying the customer the replacement cost.

2. The method according to claim 1, wherein the actual cash value is calculated based upon at least one selected from the group consisting of:
(a) the model and manufacturer of the electric energy storage device,
(b) the age of the electric energy storage device, and
(c) a depreciation algorithm.

3. The method according to claim 1, wherein the replacement cost is the cost to acquire a new electric energy storage device, either original equipment manufactured or after-market manufactured meeting OEM specifications, to replace the damaged electric energy storage device.

4. The method according to claim 1, wherein the reviewing step comprises checking whether the customer has submitted: (1) proof, or a verified statement to the effect that no other warranty or insurance coverage providing for the replacement cost of the electric energy storage device is in place for the vehicle for which a claim is being submitted, and (2) proof of accidental damage in the form of an accident report.

5. The method according to claim 1, further comprising, prior to the receiving step, the customer choosing to purchase from among the first gap coverage product and the second gap coverage product.

6. A system for policy provider for allocating risk of loss for a damaged electric energy storage device by one of a first gap coverage product of the policy provider and a second gap coverage product of the policy provider, the system comprising:
a Web server configured to receive claim information from a customer relating to the damaged electric energy storage device;
a programmed computer configured to review the received claim information to determine whether or not the electric energy storage device is covered by a vehicle collision policy that covers accidental damage to the electric energy storage deceive, the programmed computer being configured to:
(a) if the electric energy storage device is covered by a vehicle collision policy, apply the first gap coverage product by:
calculating the actual cash value of the damaged electric energy storage device;
determining the replacement cost for the damaged electric energy storage device; and
paying the customer the difference between the calculated actual cash value and the replacement cost; and
(b) if the electric energy storage device is not covered by a vehicle collision policy, apply the second gap coverage product by:
determining the replacement cost for the damaged electric energy storage device; and
paying the customer the replacement cost.

7. The system according to claim 6, wherein the actual cash value is calculated based upon at least one selected from the group consisting of:
(a) the model and manufacturer of the electric energy storage device,
(b) the age of the electric energy storage device, and
(c) a depreciation algorithm.

8. The method according to claim 6, wherein the replacement cost is the cost to acquire a new electric energy storage device, either original equipment manufactured or after-market manufactured meeting OEM specifications, to replace the damaged electric energy storage device.

9. The system according to claim 6, wherein the reviewing comprises checking whether the customer has submitted: (1) proof, or a verified statement to the effect that no other warranty or insurance coverage providing for the replacement cost of the electric energy storage device is in place for the vehicle for which a claim is being submitted, and (2) proof of accidental damage in the form of an accident report.
